(19) United States
(12) Patent Application Publication
(10) Pub. No.: US 2024/0335756 A1
(43) Pub. Date: Oct. 10, 2024

(54) RECORDING MEDIUM AND INFORMATION PROCESSING DEVICE

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 18/743,556

(22) Filed: Jun. 14, 2024

Related U.S. Application Data
(63) Continuation of application No. PCT/JP2022/041623, filed on Nov. 8, 2022.

(30) Foreign Application Priority Data
Dec. 14, 2021 (JP) 2021-202165

(51) Int. Cl. A63F 13/70

(52) U.S. Cl. CPC A63F 13/70

(57) ABSTRACT

A non-transitory computer readable recording medium stores instructions that cause a computer to execute: calculating game currency acquisition numbers that each correspond to an acquisition time; storing, in a storage, the game currency acquisition numbers; obtaining a total game currency acquisition number by adding up the game currency acquisition numbers in order of the acquisition time starting from a most recent acquisition time; determining whether the total game currency acquisition number has reached a specific number; and upon determining that the total game currency acquisition number has reached the specific number, specifying the acquisition time at which the total game currency acquisition number has reached the specific number, calculating a period of time from the specified acquisition time to a present time, and providing the player with a benefit in a game based on the calculated period of time.

### BACKGROUND

### Technical Field

The present invention relates to a recording medium storing instructions and an information processing device.

### Description of Related Art

Games in which benefits or advantages are given to players in response to the players' involvement with game currency (such as the acquisition, consumption, or purchase of game currency) have been known in the past.

Regarding this, Patent Literature 1 discloses a technique in which a player is provided with high-rarity content (benefits) when the number of times a lottery game has been played reaches a specific number, that is, when the game currency consumption number reaches a specific number.

### PATENT LITERATURE

Patent Literature 1: Japanese Patent No. 6326081

### Technological Problem to be Solved by the Invention

In such gaming technology, each player is provided with a uniform benefit or advantage, regardless of the period of time required for the quantity (monetary amount) of game currency contributed by the player to reach a specific number. However, no specific algorithm exists for giving benefits or advantages in game operations that take into account the length of time it takes players to reach that specific number. Accordingly, there has been a demand for algorithms that uniquely provide benefits or advantages in game operations such that players who contribute to enlivening the game can be sufficiently motivated to continue playing the game.

### SUMMARY

One or more embodiments of the present invention provide a technological improvement over such conventional gaming technologies discussed above. In particular, one or more embodiments of the present invention provide a recording medium storing instructions and an information processing device that enable giving benefits or advantages in game operations by a specific algorithm depending on the game currency acquisition/consumption numbers and/or the game currency purchase amount, as well as the time required, such that players who contribute to enlivening the game can be sufficiently motivated to play the game.

The non-transitory computer readable recording medium according to a first aspect of the present invention stores instructions that cause a computer to execute: calculating game currency acquisition numbers that each correspond to an acquisition time and indicate a quantity of game currency acquired by a player; storing, in a storage, the game currency acquisition numbers; obtaining a total game currency acquisition number by adding up the game currency acquisition numbers in order of the acquisition time starting from a latest (i.e., the most recent) acquisition time; monitoring whether the total game currency acquisition number has reached a specific number; and upon determining that the total game currency acquisition number has reached the specific number, specifying the acquisition time at which the total game currency acquisition number has reached the specific number, calculating a period of time from the specified acquisition time to a present time, and providing the player with a benefit in a game based on the calculated period of time such that the less the calculated period of time, the greater the benefit.

Also, the non-transitory computer readable recording medium according to a second aspect of the present invention stores instructions that cause a computer to execute: calculating game currency consumption numbers that each correspond to a consumption time and indicate a quantity of game currency consumed by a player; storing, in a storage, the game currency consumption numbers; obtaining a total game currency consumption number by adding up the game currency consumption numbers in order of the consumption time starting from a latest (i.e., the most recent) consumption time; monitoring whether the total game currency consumption number has reached a specific number; and upon determining that the total game currency consumption number has reached the specific number, specifying the consumption time at which the total game currency consumption number has reached the specific number, calculating a period of time from the specified consumption time to a present time, and providing the player with a benefit in a game based on the calculated period of time such that the less the calculated period of time, the greater the benefit.

Also, the non-transitory computer readable recording medium according to a third aspect of the present invention stores instructions that cause a computer to execute: calculating game currency purchase amounts that each correspond to a purchase time and indicate a quantity of game currency purchased by a player; storing, in a storage, the game currency purchase amounts;

obtaining a total game currency purchase amount by adding up the game currency purchase amounts in order of the purchase time starting from a latest (i.e., the most recent) purchase time; monitoring whether the total game currency purchase amount has reached a specific number; and upon determining that the total game currency purchase amount has reached the specific number, specifying the purchase time at which the total game currency purchase amount has reached the specific number, calculating a period of time from the specified purchase time to a present time, and providing the player with a benefit in a game based on the calculated period of time such that the less the calculated period of time, the greater the benefit.

Also, in a fourth aspect of the present invention, the game currency includes paid currency that can be acquired through a purchase procedure by the player.

Also, in a fifth aspect of the present invention, the benefit is to increase a quantity of a reward content in the game, and the less the calculated period of time is, the more the quantity of the reward content is increased.

Also, in a sixth aspect of the present invention, the benefit is to improve a quality of a reward content in the game, and the less the calculated period of time is, the more the quality of the reward content is improved.

Also, in a seventh aspect of the present invention, the benefit is to ease a limitation in the game, and the less the calculated period of time is, the more an amount of easing of the limitation is increased.

Also, in an eighth aspect of the present invention, the benefit is to increase a parameter of a content associated with the player, and the less the calculated period of time is, the more the parameter is increased.

Also, in a ninth aspect of the present invention, the less the calculated period of time is, the more a benefit provision period is lengthened.

Also, the information processing device according to a tenth aspect of the present invention comprises a storage; and a control device that: calculates game currency acquisition numbers that each correspond to an acquisition time and indicate a quantity of game currency acquired by a player, stores, in the storage, the game currency acquisition numbers, obtains a total game currency acquisition number by adding up the game currency acquisition numbers in order of the acquisition time starting from a latest (i.e., the most recent) acquisition time, monitors whether the total game currency acquisition number has reached a specific number, and upon determining that the total game currency acquisition number has reached the specific number, specifies the acquisition time at which the total game currency acquisition number has reached the specific number, calculates a period of time from the specified acquisition time to a present time, and provides the player with a benefit in a game based on the calculated period of time such that the less the calculated period of time, the greater the benefit.

Also, the information processing device according to an eleventh aspect of the present invention comprises a storage; and a control device that: calculates game currency consumption numbers that each correspond to a consumption time and indicate a quantity of game currency consumed by a player, stores, in the storage, the game currency consumption numbers, obtains a total game currency consumption number by adding up the game currency consumption numbers in order of the consumption time starting from a latest (i.e., the most recent) consumption time, monitors whether the total game currency consumption number has reached a specific number, and upon determining that the total game currency consumption number has reached the specific number, specifies the consumption time at which the total game currency consumption number has reached the specific number, calculates a period of time from the specified consumption time to a present time, and provides the player with a benefit in a game based on the calculated period of time such that the less the calculated period of time, the greater the benefit.

Also, the information processing device according to a twelfth aspect of the present invention comprises a storage; and a control device that: calculates game currency purchase amounts that each correspond to a purchase time and indicate a quantity of game currency purchased by a player, stores, in the storage, the game currency purchase amounts, obtains a total game currency purchase amount by adding up the game currency purchase amounts in order of the purchase time starting from a (i.e., the most recent) purchase time, monitors whether the total game currency purchase amount has reached a specific number, and upon determining that the total game currency purchase amount has reached the specific number, specifies the purchase time at which the total game currency purchase amount has reached the specific number, calculates a period of time from the specified purchase time to a present time, and provides the player with a benefit in a game based on the calculated period of time such that the less the calculated period of time, the greater the benefit.

According to one or more embodiments of the present invention, it becomes possible to give benefits or advantages in game operations by a specific algorithm depending on the game currency acquisition/consumption numbers and/or the game currency purchase amount, as well as the time required, such that players who are contributing to enlivening the game can be sufficiently motivated to play the game.

### BRIEF DESCRIPTION OF THE DRAWINGS

FIG. 1 is a block diagram showing an example of the overall configuration of a game system according to a first embodiment;

FIG. 2 is a diagram schematically showing an example of the hardware configuration of a server device;

FIG. 3 is a diagram showing an example of the hardware configuration of a smart phone, as the terminal device shown in FIG. 1;

FIG. 4 is a block diagram showing an example of the functional configuration of a server device;

FIG. 5 is a flowchart showing an example (specific example 1) of the flow of processing executed by each functional unit shown in FIG. 4 in the game system according to the first embodiment;

FIG. 6 is a diagram showing an example (specific example 1) of a notification screen according to the first embodiment;

FIG. 7 is a flowchart showing an example (specific example 2) of the flow of processing executed by each functional unit in a game system according to the first embodiment;

FIG. 8 is a diagram showing an example (specific example 2) of a notification screen according to the first embodiment;

FIG. 9 is a flowchart showing an example (specific example 3) of the flow of processing executed by each functional unit in the game system according to the first embodiment;

FIG. 10 is a diagram showing an example (specific example 3) of a notification screen according to the first embodiment;

FIG. 11 is a flowchart showing an example (specific example 1) of the flow of processing executed by each functional unit in the game system according to a second embodiment;

FIG. 12 is a diagram showing an example (specific example 1) of a notification screen according to the second embodiment;

FIG. 13 is a flowchart showing an example (specific example 2) of the flow of processing executed by each functional unit in a game system according to the second embodiment;

FIG. 14 is a diagram showing an example (specific example 2) of a notification screen according to the second embodiment;

FIG. 15 is a flowchart showing an example (specific example 3) of the flow of processing executed by each functional unit in the game system according to the second embodiment; and

FIG. 16 is a diagram showing an example (specific example 3) of the notification screen according to the second embodiment.

### DETAILED DESCRIPTION

A number of embodiments of the present invention will now be described with reference to the appended drawings. To facilitate understanding of the description, components and steps that are the same will be numbered the same as much as possible in the drawings, and redundant description will be omitted.

### First Embodiment

A first embodiment will be described now.

### Overall Configuration

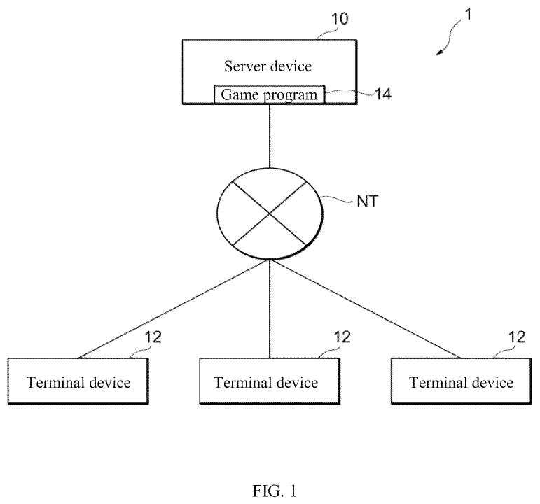

FIG. 1 is a block diagram showing an example of the overall configuration of a game system 1 according to the first embodiment.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of the game obtained by executing instructions such as a game program 14, or the instructions themselves, to the player of each terminal device 12 via the communication network NT. In the first embodiment, the server device 10 provides the instructions themselves to the players of the terminal devices 12.

Each terminal device 12 is an information processing device belonging to a player, and is an information processing device that provides a game to a player by executing the instructions received from the server device 10 after the instructions have been installed. Examples of these terminal devices 12 include video game machines, arcade game machines, mobile phones, smartphones, tablets, personal computers, and various other such devices.

### Hardware Configuration

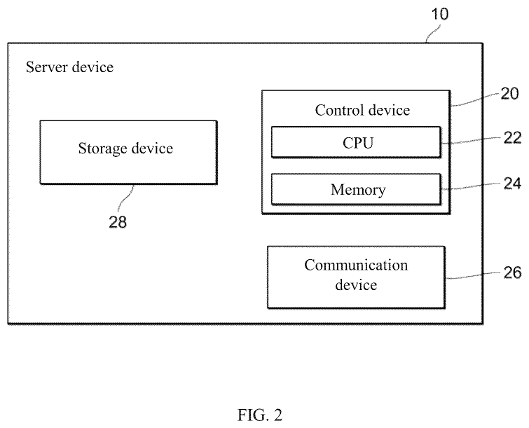

FIG. 2 is a diagram schematically showing an example of the hardware configuration of the server device 10.

As shown in FIG. 2, the server device 10 comprises a control device 20, a communication device 26, and a storage device 28. The control device 20 mainly comprises a CPU (central processing unit) 22 and a memory 24.

In the control device 20, the CPU 22 functions as various functional units by executing specific instructions stored in the memory 24, the storage device 28, or the like. These functional units will be described in detail below.

The communication device 26 is constituted by a communication interface or the like for communicating with an external device.

The communication device 26 sends and receives various kinds of information to and from the terminal device 12, for example.

The storage device 28 is constituted by a hard disk or the like. The storage device 28 stores various kinds of instructions and various kinds of information necessary for executing processing in the control device 20, including the game program 14, as well as information on processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for further comprising an operating device, a display device, and a sound output device, for example.

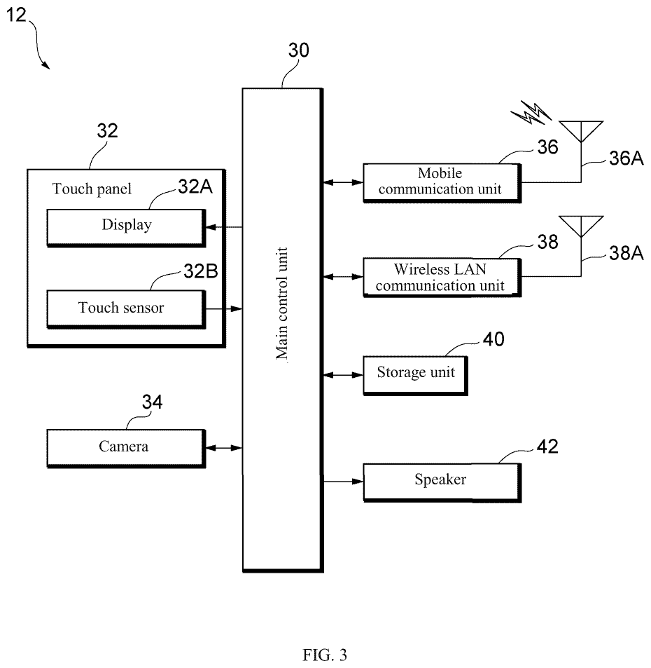

FIG. 3 is a diagram showing an example of the hardware configuration of a smartphone serving as the terminal device 12 shown in FIG. 1.

As shown in FIG. 3, the terminal device 12 comprises a main control unit (or hardware processor) 30, a touch panel (touch screen) 32, a camera 34, a mobile communication unit 36, a wireless LAN communication unit 38, a storage unit 40, and a speaker 42.

The main control unit 30 includes a CPU, a memory, and so forth. This main control unit 30 is connected to the touch panel 32 (used as a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In the first embodiment, the display 32A can display game images including button images, a cross key image, a joystick image, and other such operation input images. The touch sensor 32B can sense the input position of the player with respect to a game image.

The camera 34 has the function of capturing still and/or moving images and storing these images in the storage unit 40.

The mobile communication unit 36 is connected to a mobile communication network via an antenna 36A, and has the function of communicating with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of instructions and data, such as the game program 14, and play data indicating player information or the progress of the game in the instructions. This play data may be stored in the server device 10.

The speaker 42 has the function of outputting game sounds and so forth.

### Game Overview

Games according to the first embodiment include lottery games and quests in which a player is allowed to acquire pieces of content (for example, characters), purchase games, missions, or the like. These lottery games are sometimes referred to as gacha (loot box), raffle, summoning, or the like. These quests are sometimes referred to as battle games, dungeons, searches, or the like.

A lottery game according to the first embodiment is a game in which one or more characters (pieces of content) are chosen (randomly selected) from a lottery target character group (lottery target content group) serving as a lottery target upon an execution request (instruction) from the player to execute a lottery game and provided to the player. This lottery game is executed based on the consumption of game currency possessed by the player.

This game currency can include paid currency and unpaid currency, for example. Paid currency is paid content that can be acquired through a purchase procedure (payment) using money, a prepaid card, a credit card, electronic money, crypto assets, and so on. Examples of the paid currency include charged items (paid items), charged coins (paid coins), charged points (paid points), and so on. For instance, in the game according to the first embodiment, one charged item can be purchased for 100 yen. Meanwhile, unpaid currency is unpaid content that can be acquired by playing the game. Examples of unpaid currency include non-charged items (unpaid items), non-charged coins (unpaid coins), and non-charged points (unpaid points). Examples of executing a game may include the player logging into the game, clearing a quest for the first time, and completing a mission. Unpaid currency can be consumed just the same as paid currency in various kinds of games. For example, in the first lottery game according to the first embodiment, paid items and unpaid items may be consumed, with no distinction between the two.

In addition, in a lottery game, when the player has played the lottery game one or more times, the player may acquire reward content (such as characters, training items, etc.) as “free prizes.”

Also, a quest according to the first embodiment is a game in which a team composed of one or more characters possessed by the player and enemy characters play against each other based on an execution request (instruction) from the player to execute the quest.

For example, in an organization menu for organizing characters to be used in the quest (player character), the player can organize characters to be used in the quest by arbitrarily selecting one or more characters from his or her possessed characters.

These quests are executed on the basis of the consumption of the current stamina associated with the player. This current stamina value is recovered through the consumption of game currency (paid currency or unpaid currency). When the player clears the quest, that is, when the hit points of an enemy character (boss character) that appears at the end fall to zero or less, the player can acquire a clearance reward (reward content). Examples of this clearance reward include unpaid currency, gacha tickets, coins, training items, characters, player experience points, and so forth. An example of a training item is an item for increasing the character experience points of a character. This training item has a rarity that is set between 1 and 6, and the higher the rarity of the training item, the more the character experience value can be increased. On the other hand, if the player is unable to clear the quest, he or she can choose whether to continue the quest by consuming one game currency (a paid currency or unpaid currency) or one continuation item, or to give up on clearing the quest.

Also, a purchase game according to the first embodiment is a game in which pieces of content selected by the player can be acquired based on a purchase request (instruction) from the player to purchase the content (for example, a character). This purchase is executed based on the consumption of game currency (paid currency or unpaid currency) possessed by the player. This purchase game differs from a lottery game or a quest in that the player can reliably acquire the desired content.

With a purchase game, when the player has purchased one or more pieces of content, the player may be allowed to acquire reward content (such as characters, training items, etc.) as “free prizes.”

Also, a mission according to the first embodiment is a game in which a task assigned by the game operator is completed. Examples of this mission may include attaining a certain number of login days, number of friends, player rank, number of times a specific quest is cleared, total amount of current stamina value consumed, and so forth. When this mission is completed, the player can acquire a mission reward (reward content). Examples of this mission reward include characters, training items, and so forth.

### Functional Units

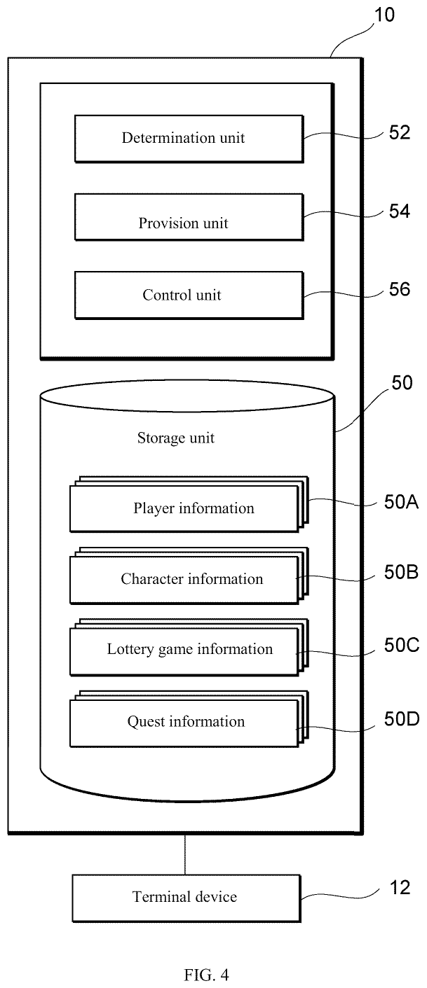

FIG. 4 is a block diagram showing an example of the functional configuration of the server device 10.

As shown in FIG. 4, the server device 10 comprises, as functional components, a storage unit (or storage) 50, a determination unit 52, provision unit 54, and a control unit 56. The storage unit 50 is realized in the form of one or more storage devices 28. Functional units other than the storage unit 50 are realized when the control device 20 executes the instructions stored in the storage device 28 or the like.

The storage unit 50 has the function of storing player information 50A, character information 50B, lottery game information 50C, quest information 50D, and so forth.

Player information 50A is stored for each player in association with the player ID of that player. This player information 50A includes, for example, the player's name and age, player rank, possessed character information, game currency information, stamina information, lottery count information, clearance count information, benefit information, and so forth.

The player rank increases when the player acquires player experience points, for example.

Possessed character information includes the character ID associated with each possessed character possessed by the player, and the ability parameters (for example, level, hit points, attack power, defense power, etc.) of each character.

Game currency information includes information on the player's involvement in game currency. This game currency information includes, for example, acquisition information, consumption information, purchase information, and so forth. Examples of types of game currency include paid currency that can be acquired through a purchase procedure by the player, and unpaid currency that can be acquired through game play.

Acquisition information includes a game currency acquisition number indicating a quantity of game currency acquired by the player. This acquisition information includes, for example, the type of game currency acquired and the game currency acquisition number, in association with each acquisition time when the player acquired the game currency. This acquisition time may be, for example, a date. For instance, if a player goes through a purchase procedure and acquires 10 charged items (paid currency), 10 charged items are added to the acquisition information, in association with the date of this purchase procedure (such as Oct. 9, 2021). Also, for example, if the player logs in and thereby acquires five non-charged items (unpaid currency) as a login bonus, five non-charged items are added to the acquisition information, in association with the date of the login (such as Oct. 10, 2021).

Consumption information includes a game currency consumption number indicating a quantity of game currency consumed by the player. This consumption information includes, for example, the type of game currency consumed and the game currency consumption number, in association with each consumption time when the player consumed the game currency. This consumption time may be, for example, a date. For example, if the player executes a lottery game and has consumed 10 charged items (paid currency), 10 paid items are added to the consumption information, in association with the date on which the lottery game was executed (such as Oct. 14, 2021). Also, for example, if the player has consumed one non-charged item (unpaid currency) by continuing a quest, one non-charged item is added to the consumption information, in association with the date of the continuation (such as Oct. 16, 2021).

In the game according to the first embodiment, if the player owns both paid currency (such as charged items) and unpaid currency (such as non-charged items), the unpaid currency is consumed preferentially. Also, in the game according to the first embodiment, when the player consumes unpaid currency, the unpaid currency with the oldest acquisition time is consumed first. Similarly, in the game according to the first embodiment, when a player consumes paid currency, the paid currency with the oldest acquisition time is consumed first.

Purchase information includes the monetary amount of the game currency purchased by the player. This purchase information includes, for example, the purchase amount of the purchased game currency (paid currency), in association with each purchase time when the player purchased the game currency (paid currency). This purchase time may be, for example, a date. For instance, if the player goes through a purchase procedure and has purchased a charged item (paid currency) worth 2,000 yen, 2,000 yen is added to the purchase information, in association with the date on which the purchase procedure was performed (such as Oct. 17, 2021).

Stamina information includes the current stamina value or the stamina upper limit value, and the stamina restoration amount. The current stamina value is the value consumed when the player executes a quest within the game. This current stamina value is restored by a specific amount (such as 1) after a certain period of time (such as 3 minutes) elapses, and is restored up to the stamina upper limit value. The stamina upper limit value is the upper limit value to which the current stamina value can be restored over time or through restoration processing. The stamina upper limit value may increase along with the player rank, for example. The stamina restoration amount includes the amount (such as 10) by which the current stamina value is restored through restoration processing. This restoration processing is executed through the consumption of game currency (for example, one charged item) by the player. This stamina restoration amount increases by a specific amount (such as 1) when the player rank goes up by 1.

Lottery count information is stored for each lottery game in association with the lottery game ID of the lottery game. The lottery count information includes the execution count, which is the number of times the player has executed a lottery game, and the limitation count (the maximum number of times the lottery game can be executed). This execution count may be initialized, for example, after a certain period of time (such as one day) has elapsed. The limitation count may include negative values (such as −100) in the event that the execution count of a lottery game has no limit.

Clearance count information is stored for each quest in association with the quest ID of the quest. The clearance count information includes the clearance count, which is the number of times the player has cleared a quest, and the limitation count (the maximum number of times the quest can be cleared). This clearance count may be initialized, for example, after a certain period of time (such as one day) has elapsed. The limitation count may include negative values (such as −100) in the event that the clearance count has no limit.

Benefit information includes the benefit class and the benefit provision period. The benefit class includes the class (grade) of the benefits provided to the player. The benefit class may comprise numerical values from 0 to 3, for example. The higher the numerical value of this benefit class, the more advantageous the benefits provided to the player are. The initial value of the benefit class is zero. If the benefit class is zero, no benefit is provided to the player. That is, when the player's benefit class is 1 or more, the provision unit 54 (discussed below) provides the player with a benefit in the game. The benefit provision period includes, for example, the period from the benefit provision start date to the provision end date. This benefit provision period is reduced by one unit of time (such as one day) every time one unit of time passes. The benefit provision period is stored when the benefit class is 1 or higher.

Character information 50B is stored for each character in association with the character ID of that character. The character information 50B may include, for example, the character name and image, ability parameter information, and rarity. This character information 50B is updated from time to time through a game update (a version upgrade or update) by the game operator.

Ability parameter information includes the initial values and maximum values for the various ability parameters of a character.

Rarity may be represented by a number from 1 to 6, for example. This number may be indicated by a number of stars, for example. A character with a high rarity is set with an ability parameter or the like that is advantageous in a quest, for example.

Lottery game information 50C is stored for each lottery game in association with the lottery game ID of the lottery game. The lottery game information 50C includes the lottery game name and cost, lottery target information, and so forth.

Cost includes the amount of game currency (paid currency or unpaid currency) required to execute one lottery. For instance, the cost for a first lottery game may be five paid items or five unpaid items.

Lottery target information includes the character IDs of the characters constituting the lottery target character group that is the lottery target of a lottery game, and the appearance frequency (weighting) associated with that character ID. Appearance frequency may be represented by a number from 1 to 10, for example. The appearance frequency is set to a low numerical value for a character with a high rarity, and to a high numerical value for a character with a low rarity. The appearance frequency may be set to different numerical values among characters of the same rarity (such as a rarity of 6). Here, the probability of drawing one character is a value obtained by dividing the appearance frequency set for that one character by the total value of the appearance frequencies set for each of the characters that constitute the lottery target character group. More specifically, if the appearance frequency set for one character is 2 and the total value of the appearance frequencies set for each of the characters that constitute the lottery target character group is 400, the probability of drawing that one character is 2/400 (0.5%).

Quest information 50D is stored for each quest in association with the quest ID of that quest. The quest information 50D includes the quest name, consumed stamina value, enemy character information, clearance reward information, and so forth.

Consumed stamina value includes the value required to execute the quest. Consumed stamina value is deducted from the player's current stamina value. The higher the difficulty of the quest, the higher the consumed stamina value may be, for example.

Enemy character information includes character IDs and ability parameters of the enemy characters that appear in a quest. These enemy characters include a boss character that appears at the end of a quest.

Clearance reward information includes the quantity and drop rate, in association with the type of clearance reward (reward content). Examples of this type include unpaid currency (such as non-charged items), gacha tickets, training items, character IDs, and player experience points. The quantity is a quantity that allows the player to acquire a clearance reward. The drop rate is the probability that the player will acquire a clearance reward. In the first embodiment, the drop rate includes a higher probability for quests with a higher difficulty level. Some clearance rewards (such as unpaid currency) may be acquired only when a quest is cleared for the first time.

The determination unit 52 is a functional unit for determining whether the quantity (monetary amount) of game currency contributed by the player has reached a specific number. In the first embodiment, the determination unit 52 determines whether the player's game currency acquisition number has reached a specific number. For example, the determination unit 52 refers to the acquisition information of the game currency information in the player information 50A and determines whether the game currency acquisition number has reached a specific number (such as 100) from a specific date in the past up to the current date (such as Oct. 31, 2021). Examples of this specific date in the past may include the date the player started the game, the first day of the current year (such as Jan. 1, 2021), the first day of the current month (such as Oct. 1, 2021), one year ago (such as Oct. 31, 2020), one month ago (such as Sep. 30, 2021), one week ago (such as Oct. 24, 2021), and so forth.

Also, in the first embodiment, the determination unit 52 determines whether the player's game currency consumption number has reached a specific number. For example, the determination unit 52 refers to the consumption information of the game currency information in the player information 50A and determines whether the game currency consumption number has reached a specific number (such as 100) from a specific date up to the present time.

Also, in the first embodiment, the determination unit 52 determines whether the player's game currency purchase amount has reached a specific number. For example, the determination unit 52 refers to the purchase information of the game currency information in the player information 50A and determines whether the game currency purchase amount has reached a specific number (such as 5,000 yen) from a specific date up to the present time.

The provision unit 54 is a functional unit for providing rewards and benefits (benefits) to the player. In the first embodiment, the provision unit 54 provides the player with a benefit in the game when the determination by the determination unit 52 is affirmative. For example, the provision unit 54 provides benefits that are more advantageous to the player in proportion to how short the time is that is required for the game currency acquisition number to reach a specific number. More specifically, the provision unit 54 refers to the acquisition information of the game currency information in the player information 50A, adds up the game currency acquisition numbers corresponding to the various acquisition times in the order of the latest acquisition time, and specifies the acquisition time when the total game currency acquisition number reaches a specific number (such as 100). The provision unit 54 then calculates the period of time from the specified acquisition time to the present time as the time required. The provision unit 54 then stores a numerical value from 1 to 3 in the benefit class of the benefit information in the player information 50A, according to the calculated period of time. For example, if the calculated period of time is less than three days, the provision unit 54 stores 3 in the benefit class, and if the period of time is at least three days but less than seven days, 2 is stored in the benefit class, and if the period of time is at least seven days, 1 is stored in the benefit class.

Also, in the first embodiment, the provision unit 54 provides benefits that are more advantageous to the player in proportion to how short the time is that is required for the game currency consumption number to reach a specific number. More specifically, the provision unit 54 refers to the consumption information of the game currency information in the player information 50A, adds up the game currency consumption numbers corresponding to the various consumption times in the order of the latest consumption time, and specifies the consumption time when the total game currency consumption number reaches a specific number (such as 100). The provision unit 54 then sets the period of time from the specified consumption time to the present time as the time required. The provision unit 54 then stores a numerical value from 1 to 3 in the benefit class of the benefit information in the player information 50A, according to the calculated period of time.

Also, in the first embodiment, the provision unit 54 provides benefits that are more advantageous to the player in proportion to how short the time is that is required for the game currency purchase amount to reach a specific number. More specifically, the provision unit 54 refers to the purchase information of the game currency information in the player information 50A, adds up the game currency purchase amounts corresponding to the various purchase times in the order of the latest purchase time, and specifies the purchase time when the total game currency purchase amount reaches a specific number (such as 5,000 yen). The provision unit 54 then calculates the period of time from the specified purchase time to the present time as the time required. The provision unit 54 then stores a numerical value from 1 to 3 in the benefit class of the benefit information in the player information 50A, according to the calculated period of time.

Specific examples of benefits and specific examples in which the provision unit 54 provides a benefit will now be described.

### (1) Increasing the Quantity of Reward Content

The benefit may be, for example, increasing the quantity of reward content in a game. Examples of this reward content may include a login bonus, “free prizes” in lottery games and purchase games, clearance rewards in quests, mission rewards in missions, and the like. A login bonus is a reward provided when the player logs into a game. For example, a login bonus may be provided to a player who logs in every given unit of time (such as one day).

The provision unit 54 may increase the quantity of reward content in proportion to how short the period of time is, for example. More specifically, if the period of time is less than three days (if the benefit class is 3), the provision unit 54 quadruples the clearance reward for a quest. Or, for example, if the period of time is at least three days and less than seven days (if the benefit class is 2), the provision unit 54 triples the clearance reward. Or, for example, if the period of time is at least seven days (if the benefit class is 1), the provision unit 54 doubles the clearance reward.

### (2) Improving the Quality of Reward Content

The benefit may be, for example, improving the quality of the reward content in a game.

For example, the provision unit 54 may improve the quality of reward content in proportion to how short the period of time is. More specifically, if the period of time is less than three days (if the benefit class is 3), the provision unit 54 increases the rarity of a mission reward (such as a character or training item) in a mission by three. Or, for example, if the period of time is at least three days and less than seven days (if the benefit class is 2), the provision unit 54 increases the rarity of the mission reward by two. Or, for example, if the period of time is at least seven days (if the benefit class is 1), the provision unit 54 increases the rarity of the mission reward by one.

### (3) Easing of Limitations

The benefit may be, for example, easing the limitations in a game. Examples of this easing of limitations may include increasing the limitation count (the maximum number of executions) set for a specific lottery game (a lottery game whose execution count is limited), increasing the limitation count (the maximum number of clearances) set for a specific quest (a quest whose clearance count is limited), increasing the limitation count for the purchase of a specific content, increasing the limit on the number of pieces of content that can be possessed (possession limit), and so forth.

For example, the provision unit 54 may increase how much a limitation is eased in proportion to how short the period of time is. More specifically, if the period of time is less than three days (if the benefit class is 3), the provision unit 54 adds three to the limitation count set for a specific lottery game in the lottery count information of the player information 50A. Or, for example, if the period of time is at least three days and less than seven days (if the benefit class is 2), the provision unit 54 adds two to the limitation count set for a specific lottery game in the lottery count information. Or, for example, if the period of time is at least seven days (if the benefit class is 1), the provision unit 54 adds one to the limitation count set for a specific lottery game in the lottery count information.

### (4) Increasing Content Parameters

The benefit may be, for example, increasing a parameter of content associated with a player. Examples of this content may include content used by the player in a quest, content that the player is borrowing from a game operator, content that the player is borrowing from another player, and so forth.

For example, the provision unit 54 may increase a parameter in proportion to how short the period of time is. More specifically, if the period of time is less than three days (if the benefit class is 3), the provision unit 54 multiplies an ability parameter (such as attack power) of a player character used in the quest by 2.5. Or, for example, if the period of time is at least three days and less than seven days (if the benefit class is 2), the provision unit 54 multiplies the ability parameter of the player character by 2. Or, for example, if the period of time is at least seven days (if the benefit class is 1), the provision unit 54 multiplies the ability parameter of the player character by 1.5.

Also, in the first embodiment, the provision unit 54 may lengthen the benefit provision period in proportion to how short the period of time is. For example, if the period of time is less than three days, the provision unit 54 sets the period for increasing the quantity of reward content to three months and stores it in the benefit provision period of the benefit information in the player information 50A. Or, for example, if the period of time is at least three days and less than seven days, the provision unit 54 sets the period for increasing the quantity of reward content to two months and stores it in the benefit provision period of the benefit information. Or, for example, if the period of time is at least seven days, the provision unit 54 sets the period for increasing the quantity of reward content to one month and stores it in the benefit provision period of the benefit information.

The control unit 56 is a functional unit for controlling the entire game. In the first embodiment, the control unit 56 updates the game currency information in the player information 50A. For example, the control unit 56 updates acquisition information, consumption information, and purchase information of game currency information.

### Specific Example 1: Flow of Processing

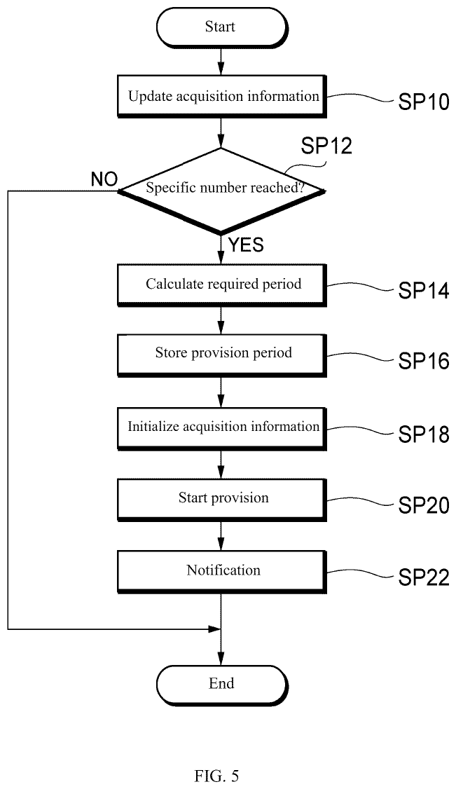

FIG. 5 is a flowchart showing an example (specific example 1) of the flow of processing executed by each functional unit shown in FIG. 4 in the game system according to the first embodiment. Also, the processing of the following steps may be started, for example, at the point when the player acquires game currency. The order and details of the following steps can be changed as needed.

### Step SP10

The control unit 56 updates the acquisition information of the game currency information in the player information 50A. For example, the control unit 56 sets the current date (such as Oct. 31, 2021) as the acquisition time, and adds the type of game currency acquired and the game currency acquisition number to the acquisition information. Then, the processing moves to the processing of step SP12.

### Step SP12

The determination unit 52 refers to the acquisition information of the game currency information in the player information 50A and determines whether the total game currency acquisition number from a past specific date (such as Oct. 1, 2021) up to the current date has reached a specific number (such as 100). Then, if the determination is affirmative, the processing moves to the processing of step SP14. On the other hand, if the determination is negative, the processing ends the processing series shown in FIG. 5.

### Step SP14

The provision unit 54 calculates the period of time, which is how long it takes for the game currency acquisition number to reach a specific number. For example, the provision unit 54 refers to the acquisition information of the game currency information in the player information 50A, adds up the game currency acquisition numbers corresponding to the various acquisition times in the order of the latest acquisition time, and specifies the acquisition time (such as Oct. 26, 2021) when the total game currency acquisition number reaches a specific number (such as 100). The provision unit 54 then calculates the period of time (such as five days) from the specified acquisition time up to the present time as the period of time. Then, the processing moves to the processing of step SP16.

### Step SP16

The provision unit 54 lengthens the benefit provision period in proportion to how short the period of time calculated in step SP14 is. For example, the provision unit 54 specifies the provision period as three months if the period of time is less than three days, specifies the provision period as two months if the period of time is at least three days and less than seven days, and specifies the provision period as one month if the period of time is at least seven days. The provision unit 54 then stores the specified provision period in the benefit provision period of the benefit information in the player information 50A. Then, the processing moves to the processing of step SP18.

### Step SP18

The control unit 56 initializes the acquisition information of the game currency information in the player information 50A. For example, the control unit 56 deletes the acquisition information from this game currency information. Then, the processing moves to the processing of step SP20.

### Step SP20

The provision unit 54 starts providing the player with benefits in a game. For example, the provision unit 54 provides a benefit that is more advantageous in proportion to how short the period of time calculated in step SP14 is. More specifically, the provision unit 54 stores 3 in the benefit class of the benefit information in the player information 50A if the period of time is less than three days, stores 2 in the benefit class if the period of time is at least three days and less than seven days, and stores 1 in the benefit class if the period of time is at least seven days. Consequently, the provision unit 54 refers to this benefit class and can increase the quantity or improve the quality when providing the player with login bonuses, “free prizes” in lottery games and purchase games, clearance rewards in quests, mission rewards in missions, and so forth. Then, the processing moves to the processing of step SP22.

### Step SP22

The control unit 56 causes the touch panel 32 to display a notification screen notifying that the provision of benefits has started.

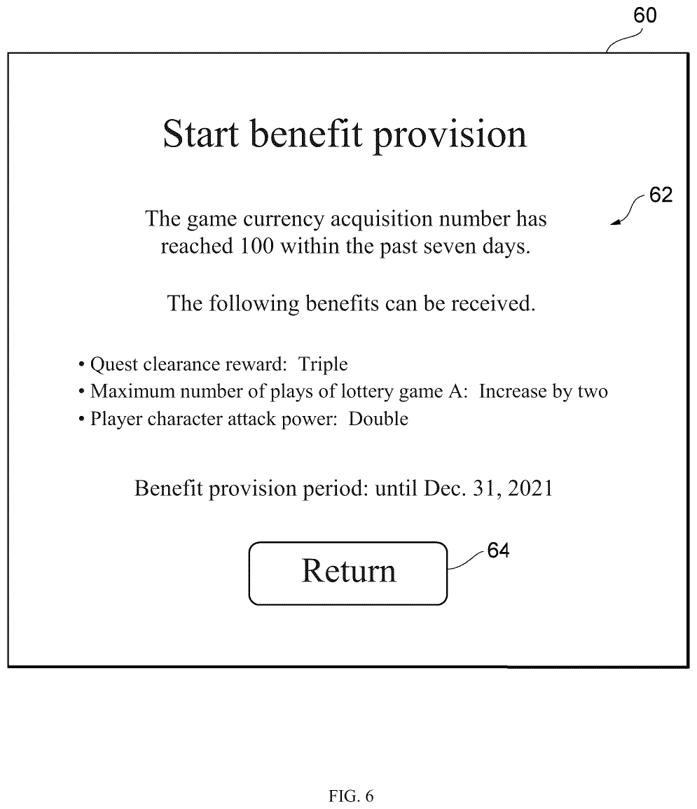

FIG. 6 is a diagram showing an example (specific example 1) of the notification screen 60 according to the first embodiment.

As shown in FIG. 6, the notification screen 60 is provided with a benefit information area 62 and a return button 64. The benefit information area 62 shows that the provision of benefits has started when the game currency acquisition number has reached a specific number in a specific time. Also, the benefit information area 62 shows details about the benefit being provided and the benefit provision period (such as the provision end date). The return button 64 is used to return to the main menu screen of the game.

Then, the processing ends the processing series shown in FIG. 5.

### Specific Example 2

In specific example 1 above, it was explained that in step SP12 above, the determination unit 52 determined whether the game currency acquisition number had reached a specific number, but it may instead determine whether the game currency consumption number has reached a specific number.

### Flow of Processing

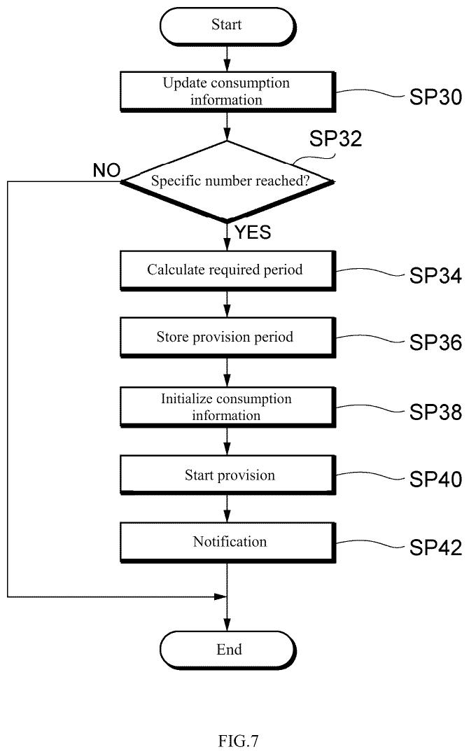

FIG. 7 is a flowchart showing an example (specific example 2) of the flow of processing executed by each functional unit in the game system according to the first embodiment. Also, the processing of the following steps may be started, for example, at the point when the player consumes game currency. The order and details of the following steps can be changed as needed.

### Step SP30

The control unit 56 updates the consumption information of the game currency information in the player information 50A. For example, the control unit 56 sets the current date (such as Oct. 31, 2021) as the consumption time, and adds the type of game currency consumed and the game currency consumption number to the consumption information. Then, the processing moves to the processing of step SP32.

### Step SP32

The determination unit 52 refers to the consumption information of the game currency information in the player information 50A and determines whether the total game currency consumption number from a past specific date (such as Oct. 1, 2021) up to the current date has reached a specific number (such as 100). Then, if the determination is affirmative, the processing moves to the processing of step SP34. On the other hand, if the determination is negative, the processing ends the processing series shown in FIG. 7.

### Step SP34

The provision unit 54 calculates the period of time, which is how long it takes for the game currency consumption number to reach a specific number. For example, the provision unit 54 refers to the consumption information of the game currency information in the player information 50A, adds up the game currency consumption numbers corresponding to the various consumption times in the order of the latest consumption time, and specifies the consumption time (such as Oct. 29, 2021) when the total game currency consumption number reaches a specific number (such as 100). The provision unit 54 then calculates the period of time (such as 2 days) from the specified consumption time up to the present time as the period of time. Then, the processing moves to the processing of step SP36.

### Step SP36

The processing in step SP36 is the same as the processing in step SP16 above, and will not be described again. Then, the processing moves to the processing of step SP38.

### Step SP38

The control unit 56 initializes the consumption information of the game currency information in the player information 50A. For example, the control unit 56 deletes the consumption information from this game currency information. Then, the processing moves to the processing of step SP40.

### Step SP40

The processing in step SP40 is the same as the processing in step SP20 above, and will not be described again. Then, the processing moves to the processing of step SP42.

### Step SP42

The control unit 56 causes the touch panel 32 to display a notification screen notifying that the provision of benefits has started.

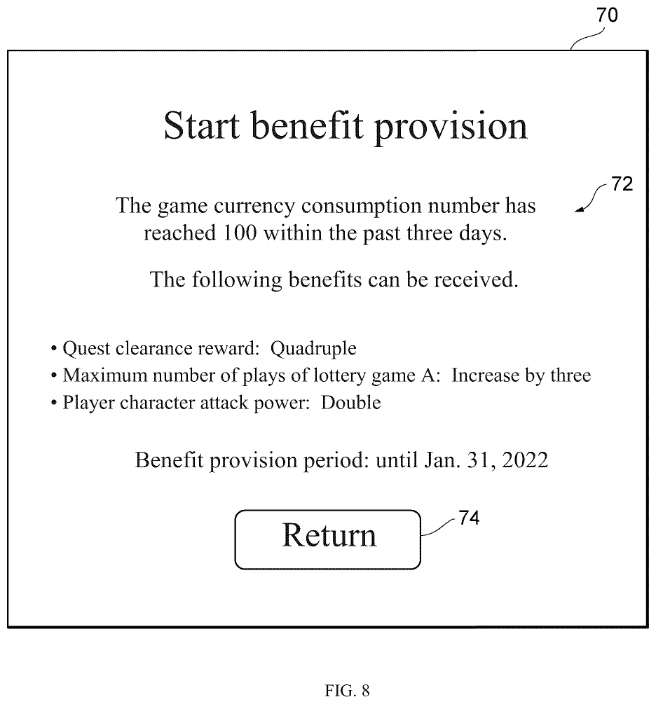

FIG. 8 is a diagram showing an example (specific example 2) of the notification screen 70 according to the first embodiment.

As shown in FIG. 8, the notification screen 70 is provided with a benefit information area 72 and a return button 74. The benefit information area 72 shows that the provision of benefits has started when the game currency consumption number has reached a specific number in a specific time.

Then, the processing ends the processing series shown in FIG. 7.

### Specific Example 3

In specific example 1 above, it was explained that in step SP12 above, the determination unit 52 determined whether the game currency acquisition number had reached a specific number, but it may instead determine whether the game currency purchase amount has reached a specific number.

### Flow of Processing

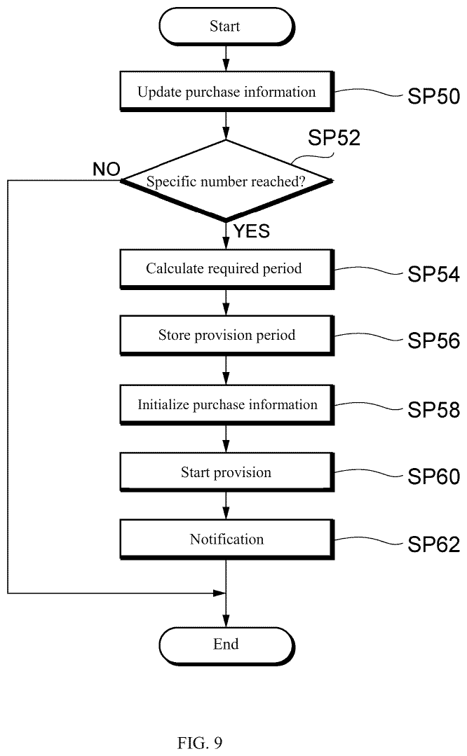

FIG. 9 is a flowchart showing an example (specific example 3) of the flow of processing executed by each functional unit in the game system according to the first embodiment. Also, the processing of the following steps may be started, for example, at the point when the player acquires game currency (paid currency). The order and details of the following steps can be changed as needed.

### Step SP50

The control unit 56 updates the purchase information of the game currency information in the player information 50A. For example, the control unit 56 sets the current date (such as Oct. 31, 2021) as the purchase date, and adds the game currency purchase amount of the purchased game currency (paid currency) to the purchase information. Then, the processing moves to the processing of step SP52.

### Step SP52

The determination unit 52 refers to the purchase information of the game currency information in the player information 50A and determines whether the total game currency purchase amount from a past specific date (such as Oct. 1, 2021) up to the current date has reached a specific number (such as 5,000 yen). Then, if the determination is affirmative, the processing moves to the processing of step SP54. On the other hand, if the determination is negative, the processing ends the processing series shown in FIG. 9.

### Step SP54

The provision unit 54 calculates the period of time, which is how long it takes for the game currency purchase amount to reach a specific number. For example, the provision unit 54 refers to the purchase information of the game currency information in the player information 50A, adds up the game currency purchase amounts corresponding to the various purchase times in the order of the latest purchase time, and specifies the purchase time (such as Oct. 1, 2021) when the total game currency purchase amount reaches a specific number (such as 5,000 yen). The provision unit 54 then calculates the period of time (such as 30 days) from the specified purchase time up to the present time as the time required. Then, the processing moves to the processing of step SP56.

### Step SP56

The processing in step SP56 is the same as the processing in step SP16 above, and will not be described again. Then, the processing moves to the processing of step SP58.

### Step SP58

The control unit 56 initializes the purchase information of the game currency information in the player information 50A. For example, the control unit 56 deletes the purchase information from this game currency information. Then, the processing moves to the processing of step SP60.

### Step SP60

The processing in step SP60 is the same as the processing in step SP20 above, and will not be described again. Then, the processing moves to the processing of step SP62.

### Step SP62

The control unit 56 causes the touch panel 32 to display a notification screen notifying that the provision of benefits has started.

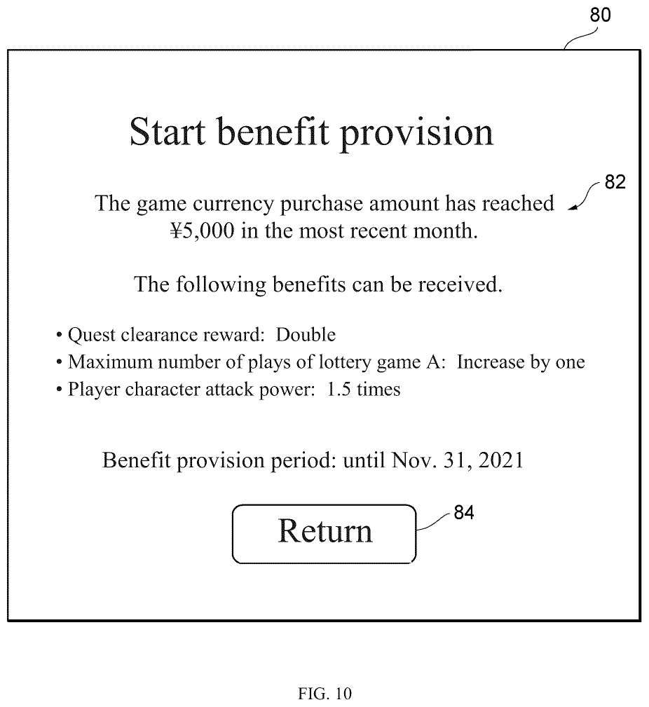

FIG. 10 is a diagram showing an example (specific example 3) of the notification screen 80 according to the first embodiment.

As shown in FIG. 10, the notification screen 80 is provided with a benefit information area 82 and a return button 84. The benefit information area 82 shows that the provision of benefits has started when the game currency purchase amount has reached a specific number in a specific time.

Then, the processing ends the processing series shown in FIG. 9.

### Technical Effect

In the first embodiment, a computer is made to function as a storage unit 50 for storing the game currency acquisition number, indicating the quantity of game currency acquired by the player; a determination unit 52 for determining whether the game currency acquisition number has reached a specific number; and a provision unit 54 for providing the player with benefits in the game if the determination is affirmative, wherein the provision unit 54 provides benefits that are more advantageous to the player in proportion to how short the time is that is required for the game currency acquisition number to reach the specific number.

With this configuration, more advantageous benefits are provided in proportion to how short the time is that is required for the game currency acquisition number to reach a specific number, so players who are contributing to enlivening the game can be sufficiently motivated to play the game.

Also, in the first embodiment, a computer is made to function as a storage unit 50 for storing a game currency consumption number indicating a quantity of game currency consumed by the player; a determination unit 52 for determining whether the game currency consumption number has reached a specific number; and a provision unit 54 for providing the player with benefits in the game if the determination is affirmative, wherein the provision unit 54 provides benefits that are more advantageous to the player in proportion to how short the time is that is required for the game currency consumption number to reach the specific number.

With this configuration, more advantageous benefits are provided in proportion to how short the time is that is required for the game currency consumption number to reach a specific number, so players who are contributing to enlivening the game can be sufficiently motivated to play the game.

Also, in the first embodiment, a computer is made to function as a storage unit 50 for storing a game currency purchase amount indicating an amount of game currency purchased by the player; a determination unit 52 for determining whether the game currency purchase amount has reached a specific number; and a provision unit 54 for providing the player with benefits in the game if the determination is affirmative, wherein the provision unit 54 provides benefits that are more advantageous to the player in proportion to how short the time is that is required for the game currency purchase amount to reach the specific number.

With this configuration, more advantageous benefits are provided in proportion to how short the time is that is required for the game currency purchase amount to reach a specific number, so players who are contributing to enlivening the game can be sufficiently motivated to play the game.

Also, in the first embodiment, the game currency includes paid currency that can be acquired when the player goes through a purchase procedure.

With this configuration, advantageous benefits are more likely to be provided to players who have purchased paid currency, so those players can be sufficiently motivated to play the game.

Also, in the first embodiment, the benefit is to increase the quantity of reward content in the game, and the provision unit 54 increases the quantity of reward content in proportion to how short the period of time is.

With this configuration, the shorter the period of time, the more the provided quantity of reward content increases, so players who are contributing to enlivening the game can be sufficiently motivated to play the game.

Also, in the first embodiment, the benefit is to improve the quality of the reward content in the game, and the provision unit 54 improves the quality of the reward content in proportion to how short the period of time is.

With this configuration, the shorter the period of time, the higher the quality of the reward content provided, so players who are contributing to enlivening the game can be sufficiently motivated to play the game.

Also, in the first embodiment, the benefit is to ease limitations in the game, and the provision unit 54 increases the amount of easing of the limitations in proportion to how short the period of time is.

With this configuration, the shorter the period of time, the more the limitations in the game are eased, so players who are contributing to enlivening the game can be sufficiently motivated to play the game.

Also, in the first embodiment, the benefit is to increase a parameter of content associated with the player, and the provision unit 54 increases the parameter in proportion to how short the period of time is.

With this configuration, the shorter the period of time, the more a parameter of content associated with the player is increased, so players who are contributing to enlivening the game can be sufficiently motivated to play the game.

Also, in the first embodiment, the provision unit 54 lengthens the benefit provision period in proportion to how short the period of time is.

With this configuration, the shorter the period of time, the longer the period in which the benefit is provided, so players who are contributing to enlivening the game can be sufficiently motivated to play the game.

### Second Embodiment

A second embodiment will be described now.

The second embodiment differs from the first embodiment in that the benefit class of the benefit information in the player information 50A is either 0 or 1, the determination unit 52 makes a first determination as well as a second determination, and the provision unit 54 provides a benefit if the first determination or the second determination is affirmative. Aspects of the configuration and functions of the game system according to the second embodiment that are the same as those of the game system according to the first embodiment are omitted from the description below.

In the second embodiment, the determination unit 52 makes a first determination to determine whether the game currency acquisition number has reached a first specific number in a first specific period, and a second determination to determine whether the game currency acquisition number has reached a second specific number in a second specific period. Examples of this first specific period may include the most recent 24 hours (the 24 hours leading up to the determination time), the most recent week (the seven days leading up to the determination time), the first third of the current month (such as from October 1 to Oct. 10, 2021), and so forth. Also, the second specific period is longer than the first specific period. Examples of this second specific period may include the most recent week, the most recent month (the 30 days leading up to the determination time), the most recent year (the 365 days leading up to the determination time), the current month (such as from October 1 to Oct. 31, 2021), or from the day the player started the game up to the determination time. The first specific number may be, for example, 100. Also, the second specific number is greater than the first specific number, for example, 200. The first specific number is set in order to extract players who acquire game currency very frequently, and therefore can be changed according to the first specific period. Also, the second specific number is set in order to extract players who acquire game currency more frequently than usual, and therefore can be changed according to the second specific period.

For example, the determination unit 52 refers to the acquisition information of the game currency information in the player information 50A and determines whether the game currency acquisition number has reached the first specific number (such as 100) or the second specific number (such as 200).

Also, in the second embodiment, the determination unit 52 makes a first determination to determine whether the game currency consumption number has reached a first specific number in a first specific period, and a second determination to determine whether the game currency consumption number has reached a second specific number in a second specific period. The first specific number may be, for example, 100. Also, the second specific number is greater than the first specific number, for example, 200. The first specific number is set in order to extract players who consume game currency very frequently, and therefore can be changed according to the first specific period. Also, the second specific number is set in order to extract players who consume game currency more frequently than usual, and therefore can be changed according to the second specific period.

For example, the determination unit 52 refers to the consumption information of the game currency information in the player information 50A and determines whether the game currency consumption number has reached the first specific number (such as 100) or the second specific number (such as 200).

Also, in the second embodiment, the determination unit 52 makes a first determination to determine whether the game currency purchase amount has reached a first specific number in a first specific period, and a second determination to determine whether the game currency purchase amount has reached a second specific number in a second specific period. The first specific number may be, for example, 2,500 yen. Also, the second specific number is greater than the first specific number, for example, 5,000 yen. The first specific number is set in order to extract players who purchase game currency very frequently, and therefore can be changed according to the first specific period. Also, the second specific number is set in order to extract players who purchase game currency more frequently than usual, and therefore can be changed according to the second specific period.

For example, the determination unit 52 refers to the purchase information of the game currency information in the player information 50A and determines whether the game currency purchase amount has reached the first specific number (such as 2,500 yen) or the second specific number (such as 5,000 yen).

In the second embodiment, the provision unit 54 provides the player with a benefit in the game if the first determination or the second determination is affirmative. For example, if the first determination or the second determination is affirmative, the provision unit 54 stores 1 in the benefit class of the benefit information in the player information 50A. Specific examples of benefits, and specific examples in which the provision unit 54 provides a benefit will now be described.

### (1) Making Reward Content Quantities the Same

The benefit may be, for example, increasing the quantity of reward content in a game.

For example, the provision unit 54 may set the quantity of reward content to be the same when the first determination is affirmative and when the second determination is affirmative. More specifically, when the first determination or the second determination is affirmative, the provision unit 54 triples the amount of clearance rewards for a quest. That is, the provision unit 54 triples the amount of clearance reward when the benefit class of the benefit information in the player information 50A is 1.

### (2) Making the Quality of Reward Content the Same

The benefit may be, for example, improving the quality of reward content in the game.

For example, the provision unit 54 may set the quality of the reward content to be the same when the first determination is affirmative and when the second determination is affirmative. More specifically, when the first determination or the second determination is affirmative, the provision unit 54 increases the rarity of a mission reward (such as a character or training item) in a mission by two. That is, the provision unit 54 increases the rarity of the mission reward by two when the benefit class of the benefit information in the player information 50A is 1.

### (3) Easing of Limitations

The benefit may be, for example, easing the limitations in a game.

For example, the provision unit 54 may set the amount by which limitations are eased to be the same when the first determination is affirmative and when the second determination is affirmative. More specifically, when the first determination or the second determination is affirmative, the provision unit 54 adds two to the limitation count (the maximum number of clearances) set for a specific quest in the clearance count information of the player information 50A. That is, the provision unit 54 adds two to the limitation count set for a specific quest when the benefit class of the benefit information in the player information 50A is 1.

### (4) Increasing Content Parameters

The benefit may be, for example, increasing a parameter of content associated with a player. For example, the provision unit 54 may set the amount of increase in a parameter to be the same when the first determination is affirmative and when the second determination is affirmative. More specifically, when the first determination or the second determination is affirmative, the provision unit 54 doubles an ability parameter (such as hit points) of a player character. That is, the provision unit 54 doubles the ability parameter of the player character when the benefit class of the benefit information in the player information 50A is 1.

Also, in the second embodiment, the provision unit 54 may set the benefit provision period to be the same when the first determination is affirmative and when the second determination is affirmative. For example, if the first determination is affirmative or the second determination is affirmative, the provision unit 54 sets the period for increasing the quantity of reward content to two months, and stores this as the benefit provision period of the benefit information in the player information 50A.

Also, if the first determination is affirmative, the provision unit 54 may make the benefit provision period longer than when the second determination is affirmative. For example, if the first determination is affirmative, the provision unit 54 sets the period for improving the quality of the reward content to three months, and stores this in the benefit provision period of the benefit information in the player information 50A. Meanwhile, if the second determination is affirmative, the provision unit 54 sets the period for improving the quality of the reward content to two months, and stores this in the benefit provision period of the benefit information.

Also, if the first determination is affirmative, the provision unit 54 may make the benefit provision period shorter than when the second determination is affirmative. For example, if the first determination is affirmative, the provision unit 54 sets the period during which limitations in the game are eased to two months, and stores this in the benefit provision period of the benefit information in the player information 50A. Meanwhile, if the second determination is affirmative, the provision unit 54 sets the period during which limitations in the game are eased to three months, and stores this in the benefit provision period of the benefit information.

### Specific Example 1: Flow of Processing

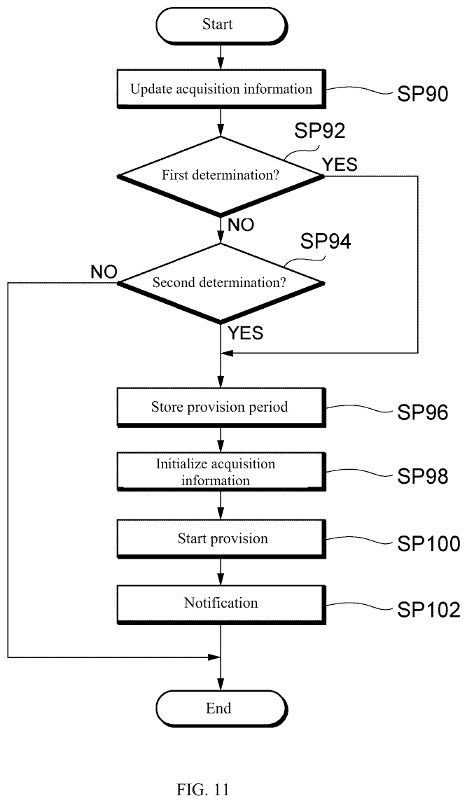

FIG. 11 is a flowchart showing an example (specific example 1) of the flow of processing executed by each functional unit in the game system according to the second embodiment. Also, the processing of the following steps may be started, for example, at the point when the player acquires game currency. The order and details of the following steps can be changed as needed.

### Step SP70

The processing in step SP70 is the same as the processing in step SP10 above, and will not be described again. Then, the processing moves to the processing of step SP72.

### Step SP72

The determination unit 52 refers to the acquisition information of the game currency information in the player information 50A and makes a first determination to determine whether the total game currency acquisition number in a first specific period (such as the most recent week) has reached a first specific number (such as 100). Then, if the first determination is affirmative, the processing moves to the processing of step SP76. On the other hand, if the first determination is negative, the processing moves to the processing of step SP74.

### Step SP74

The determination unit 52 refers to the acquisition information of the game currency information in the player information 50A and makes a second determination to determine whether the total game currency acquisition number in a second specific period (such as the most recent month) has reached a second specific number (such as 200). Then, if the second determination is affirmative, the processing moves to the processing of step SP76. On the other hand, if the second determination is negative, the processing ends the processing series shown in FIG. 11.

### Step SP76

If the first determination is affirmative in step SP72, the provision unit 54 specifies the benefit provision period to be three months. On the other hand, if the second determination is affirmative in step SP74, the provision unit 54 specifies the benefit provision period to be two months. The provision unit 54 then stores the specified provision period in the benefit provision period of the benefit information in the player information 50A. Then, the processing moves to the processing of step SP78.

### Step SP78

The processing in step SP78 is the same as the processing in step SP18 above, and will not be described again. Then, the processing moves to the processing of step SP80.

### Step SP80

The provision unit 54 starts providing the player with benefits in a game. For example, the provision unit 54 stores 1 in the benefit class of the benefit information in the player information 50A. That is, the provision unit 54 sets the content of the benefit to be the same when the first determination is affirmative and when the second determination is affirmative. Consequently, the provision unit 54 can refer to the benefit class to increase the limitation count set for a specific lottery game or quest, or to increase the parameter of content associated with the player. Then, the processing moves to the processing of step SP82.

### Step SP82

The control unit 56 causes the touch panel 32 to display a notification screen notifying that the provision of benefits has started.

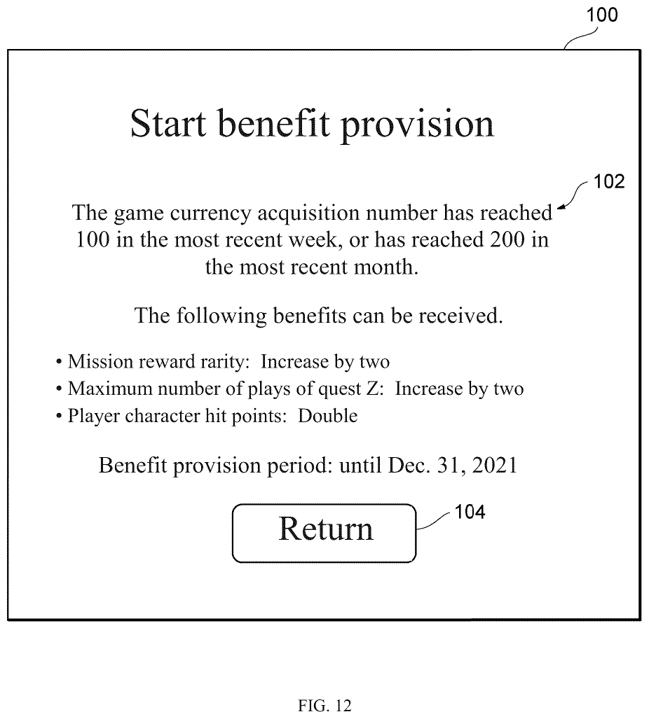

FIG. 12 is a diagram showing an example (specific example 1) of the notification screen 90 according to the second embodiment.

As shown in FIG. 12, the notification screen 90 is provided with a benefit information area 92 and a return button 94. The benefit information area 92 shows that the provision of benefits has started when the game currency acquisition number has reached a first specific number in a first specific period, or when the game currency acquisition number has reached a second specific number in a second specific period.

Then, the processing ends the processing series shown in FIG. 11.

### Specific Example 2

In specific example 1 above, it was explained that in step SP72 or step SP74 above, the determination unit 52 determined whether the game currency acquisition number had reached the first specific number or the second specific number, but it may instead determine whether the game currency consumption number has reached a first specific number or a second specific number.

### Flow of Processing

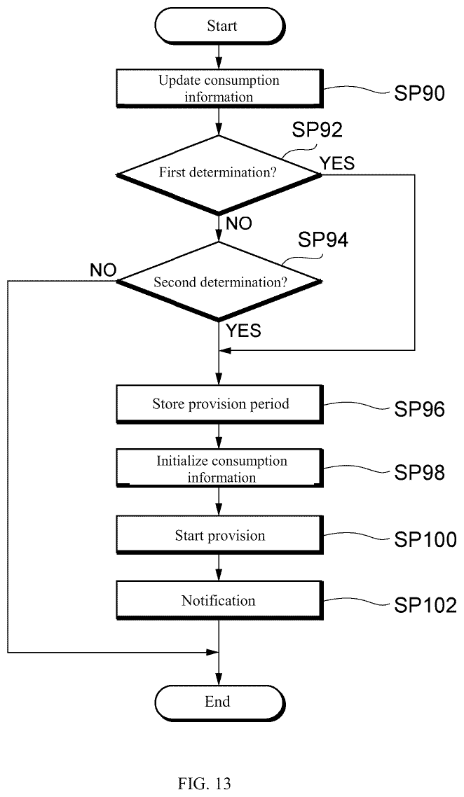

FIG. 13 is a flowchart showing an example (specific example 2) of the flow of processing executed by each functional unit in the game system according to the second embodiment. Also, the processing of the following steps may be started, for example, at the point when the player consumes game currency. The order and details of the following steps can be changed as needed.

### Step SP90

The processing in step SP90 is the same as the processing in step SP30 above, and will not be described again. Then, the processing moves to the processing of step SP92.

### Step SP92

The determination unit 52 refers to the consumption information of the game currency information in the player information 50A and makes a first determination to determine whether the total game currency consumption number in a first specific period (such as the most recent week) has reached a first specific number (such as 100). Then, if the first determination is affirmative, the processing moves to the processing of step SP96. On the other hand, if the first determination is negative, the processing moves to the processing of step SP94.

### Step SP94

The determination unit 52 refers to the consumption information of the game currency information in the player information 50A and makes a second determination to determine whether the total game currency consumption number in a second specific period (such as the most recent month) has reached a second specific number (such as 200). Then, if the second determination is affirmative, the processing moves to the processing of step SP96. On the other hand, if the second determination is negative, the processing ends the processing series shown in FIG. 13.

### Step SP96

If the first determination is affirmative in step SP92, the provision unit 54 specifies the benefit provision period to be two months. On the other hand, if the second determination is affirmative in step SP94, the provision unit 54 specifies the benefit provision period to be three months. The provision unit 54 then stores the specified provision period in the benefit provision period of the benefit information in the player information 50A. Then, the processing moves to the processing of step SP98.

### Step SP98

The processing in step SP98 is the same as the processing in step SP38 above, and will not be described again. Then, the processing moves to the processing of step SP100.

### Step SP100

The processing in step SP100 is the same as the processing in step SP80 above, and will not be described again. Then, the processing moves to the processing of step SP102.

### Step SP102

The control unit 56 causes the touch panel 32 to display a notification screen notifying that the provision of benefits has started.

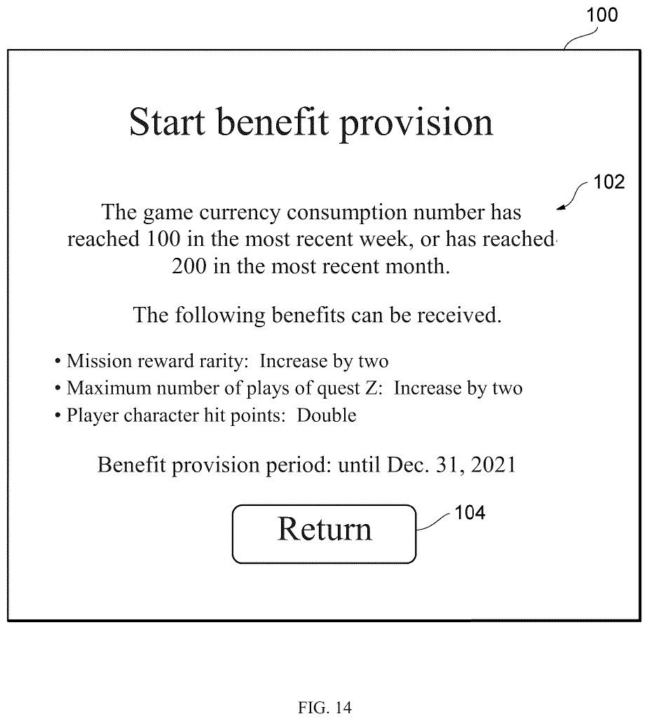

FIG. 14 is a diagram showing an example (specific example 2) of the notification screen 100 according to the second embodiment.

As shown in FIG. 14, the notification screen 100 is provided with a benefit information area 102 and a return button 104. The benefit information area 92 shows that the provision of benefits has started when the game currency consumption number has reached a first specific number in a first specific period, or when the game currency consumption number has reached a second specific number in a second specific period.

Then, the processing ends the processing series shown in FIG. 13.

### Specific Example 3

In specific example 1 above, it was explained that in step SP72 or step SP74 above, the determination unit 52 determined whether the game currency acquisition number had reached the first specific number or the second specific number, but it may instead determine whether the game currency purchase amount has reached a first specific number or a second specific number.

### Flow of Processing

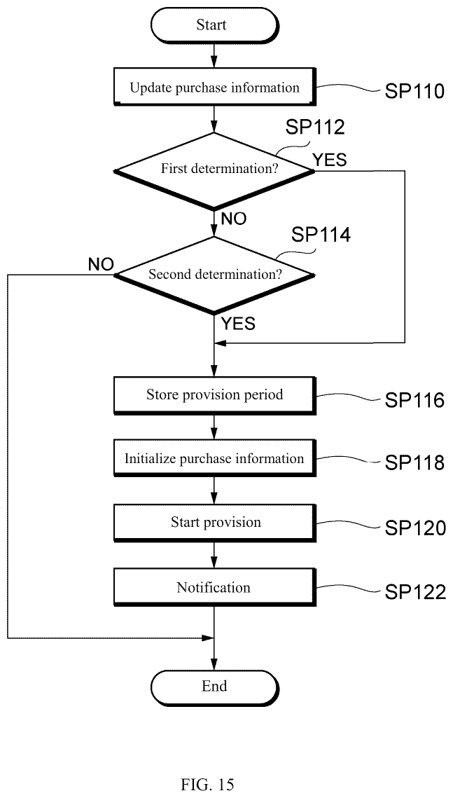

FIG. 15 is a flowchart showing an example (specific example 3) of the flow of processing executed by each functional unit in the game system according to the second embodiment. Also, the processing of the following steps may be started, for example, at the point when the player purchases game currency. The order and details of the following steps can be changed as needed.

### Step SP110

The processing in step SP110 is the same as the processing in step SP50 above, and will not be described again. Then, the processing moves to the processing of step SP112.

### Step SP112

The determination unit 52 refers to the purchase information of the game currency information in the player information 50A and makes a first determination to determine whether the total game currency purchase amount in a first specific period (such as the most recent week) has reached a first specific number (such as 2,500 yen). Then, if the first determination is affirmative, the processing moves to the processing of step SP116. On the other hand, if the first determination is negative, the processing moves to the processing of step SP114.

### Step SP114

The determination unit 52 refers to the purchase information of the game currency information in the player information 50A and makes a second determination to determine whether the total game currency purchase amount in a second specific period (such as the most recent month) has reached a second specific number (such as 5,000 yen). Then, if the second determination is affirmative, the processing moves to the processing of step SP116. On the other hand, if the second determination is negative, the processing ends the processing series shown in FIG. 15.

### Step SP116

The provision unit 54 specifies the benefit provision period as three months both when the first determination is affirmative in step SP112 and when the second determination is affirmative in step SP114. The provision unit 54 then stores the specified provision period in the benefit provision period of the benefit information in the player information 50A. Then, the processing moves to the processing of step SP118.

### Step SP118

The processing in step SP118 is the same as the processing in step SP58 above, and will not be described again. Then, the processing moves to the processing of step SP120.

### Step SP120

The processing in step SP120 is the same as the processing in step SP80 above, and will not be described again. Then, the processing moves to the processing of step SP122.

### Step SP122

The control unit 56 causes the touch panel 32 to display a notification screen notifying that the provision of benefits has started.

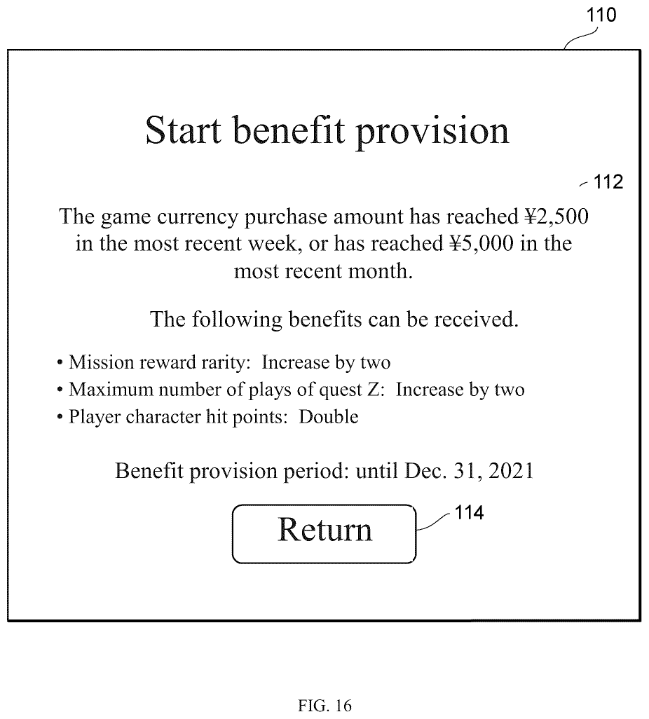

FIG. 16 is a diagram showing an example (specific example 3) of the notification screen 110 according to the second embodiment.

As shown in FIG. 16, the notification screen 110 is provided with a benefit information area 112 and a return button 114. The benefit information area 112 shows that the provision of benefits has started when the game currency purchase amount has reached a first specific number in a first specific period, or when the game currency purchase amount has reached a second specific number in a second specific period.

Then, the processing ends the processing series shown in FIG. 15.

### Technical Effect

As described above, in the second embodiment, a computer is made to function as a storage unit 50 for storing the game currency acquisition number indicating the quantity of game currency acquired by the player; a determination unit 52 for making a first determination to determine whether the game currency acquisition number has reached a first specific number in a first specific period, and a second determination to determine whether the game currency acquisition number has reached a second specific number, which is greater than the first specific number, in a second specific period, which is longer than the first specific period; and a provision unit 54 for providing the player with benefits in the game if the first determination or the second determination is affirmative.

With this configuration, a player whose game currency acquisition number has reached a first specific number in a first specific period is provided benefits even if this game currency acquisition number has not reached the second specific number, which is greater than the first specific number, in the second specific period, which is longer than the first specific period. Therefore, players with a large game currency acquisition number in the first specific period (a short period), that is, players who are contributing to enlivening the game, can be sufficiently motivated to play the game.

Also, in the second embodiment, a computer is made to function as a storage unit 50 for storing a game currency consumption number indicating a quantity of game currency consumed by the player; a determination unit 52 for making a first determination to determine whether the game currency consumption number has reached a first specific number in a first specific period, and a second determination to determine whether the game currency consumption number has reached a second specific number, which is greater than the first specific number, in a second specific period, which is longer than the first specific period; and a provision unit 54 for providing the player with benefits in the game if the first determination or the second determination is affirmative.

With this configuration, a player whose game currency consumption number has reached a first specific number in a first specific period is provided benefits even if this game currency consumption number has not reached the second specific number, which is greater than the first specific number, in the second specific period, which is longer than the first specific period. Therefore, players with a large game currency consumption number in the first specific period (a short period), that is, players who are contributing to enlivening the game, can be sufficiently motivated to play the game.

Also, in the second embodiment, a computer is made to function as a storage unit 50 for storing a game currency purchase amount indicating an amount of game currency purchased by the player; a determination unit 52 for making a first determination to determine whether the game currency purchase amount has reached a first specific number in a first specific period, and a second determination to determine whether the game currency purchase amount has reached a second specific number, which is greater than the first specific number, in a second specific period, which is longer than the first specific period; and a provision unit 54 for providing the player with benefits in the game if the first determination or the second determination is affirmative.

With this configuration, a player whose game currency purchase amount has reached a first specific number in a first specific period is provided benefits even if this game currency purchase amount has not reached the second specific number, which is greater than the first specific number, in the second specific period, which is longer than the first specific period. Therefore, players with a large game currency purchase amount in the first specific period (a short period), that is, players who are contributing to enlivening the game, can be sufficiently motivated to play the game.

Also, in the second embodiment, the game currency includes paid currency that can be acquired when the player goes through a purchase procedure.

With this configuration, benefits are more likely to be provided to players who have purchased paid currency during the first specific period, so those players can be sufficiently motivated to play the game.

Also, in the second embodiment, the benefit is to increase the quantity of reward content in the game, and the provision unit 54 sets the quantity of the reward content to be the same when the first determination is affirmative and when the second determination is affirmative.

With this configuration, the quantity of reward content provided increases, so players who have contributed to enlivening the game in the first specific period can be sufficiently motivated to play the game.

Also, in the second embodiment, the benefit is to improve the quality of the reward content in a game, so the provision unit 54 sets the quality of the reward content to be the same when the first determination is affirmative and when the second determination is affirmative.

With this configuration, the quality of reward content provided improves, so players who have contributed to enlivening the game in the first specific period can be sufficiently motivated to play the game.

Also, in the second embodiment, the benefit is to ease limitations in the game, and the provision unit 54 sets the easing of limitations to be the same when the first determination is affirmative and when the second determination is affirmative.

With this configuration, the limitations in the game are eased, so players who have contributed to enlivening the game in the first specific period can be sufficiently motivated to play the game.

Also, in the second embodiment, the benefit is to increase a parameter of content associated with the player, and the provision unit 54 sets the amount of increase in the parameter to be the same when the first determination is affirmative and when the second determination is affirmative.

With this configuration, a parameter of content associated with the player increases, so players who have contributed to enlivening the game during the first specific period can be sufficiently motivated to play the game.

Also, in the second embodiment, the provision unit 54 may set the benefit provision period to be the same when the first determination is affirmative and when the second determination is affirmative.

With this configuration, the benefit provision period is lengthened, so players who have contributed to enlivening the game during the first specific period can be sufficiently motivated to play the game.

Also, in the second embodiment, the provision unit 54 makes the benefit provision period longer when the first determination is affirmative than when the second determination is affirmative.

With this configuration, when the first determination is affirmative, the benefit provision period is longer than when the second determination is affirmative, so players who have contributed to enlivening the game during the first specific period can be sufficiently motivated to play the game.

Also, in the second embodiment, the provision unit 54 makes the benefit provision period shorter when the first determination is affirmative than when the second determination is affirmative.

With this configuration, since the provision period corresponds to the quantity (monetary amount) of game currency contributed by the player, fairness among the players can be ensured.

### Modifications

The present invention is not limited to or by the above specific examples. That is, suitable design changes made to the above specific examples by a person skilled in the art are also encompassed by the scope of the present invention as long as they still have the features of the present invention. Also, the elements of the embodiments described above and the modified examples (discussed below) can be combined to the extent that this is technically possible, and these combinations are also encompassed by the scope of the present invention as long as they still have the features of the present invention.

For example, in the first embodiment, increasing the quantity of reward content, improving the quality of reward content, etc., were given as specific examples of benefits, but the benefit may instead be making the appearance of the player's avatar or player characters more attractive, increasing the amount of restoration of the player's current stamina value (the amount of restoration over time or through restoration processing), providing special content (such as characters) to the player, granting the player the right to execute a special lottery or quest, or the like.

Also, in the first embodiment, a situation was described in which the provision unit 54 lengthened the benefit provision period in proportion to how short the period of time was, but the provision period may be set to be the same regardless of the period of time.

Also, in the first and second embodiments, a situation was described in which each functional unit executed processing at the point when the player contributed game currency, but this may instead be executed at a predetermined point (such as at midnight every day, at midnight every Sunday, at midnight on the 1st of every month, etc.).

Also, in the first embodiment, a situation was described in which the determination unit 52 determined whether the game currency acquisition number, etc., had reached a specific number from a specific date in the past up to the current date, but it may instead determine whether the game currency acquisition number, etc., has reached a specific number in a specific period of time (such as one week) since a specific date in the past.

Also, in the second embodiment, a situation was described in which the determination unit 52 made the second determination immediately after making the first determination, but the first determination and the second determination may be made at different times. For example, the determination unit 52 may make the first determination after a first specific period has elapsed (such as on the 10th of every month), and may make the second determination after a second specific period has elapsed (such as at the end of each month).

Also, in the first and second embodiments, a situation was described in which the content was mainly a character, but it may instead be any of various items such as weapons or armor, cards, avatars, coins, points, etc.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10 . . . server device (computer), 12 . . . terminal device, 50 . . . storage unit, 52 . . . determination unit, 54 . . . provision unit

What is claimed is:

1. A non-transitory computer readable recording medium storing instructions that cause a computer to execute:
calculating game currency acquisition numbers that each correspond to an acquisition time and indicate a quantity of game currency acquired by a player;
storing, in a storage, the game currency acquisition numbers;
obtaining a total game currency acquisition number by adding up the game currency acquisition numbers in order of the acquisition time starting from a most recent acquisition time;
monitoring whether the total game currency acquisition number has reached a specific number; and
upon determining that the total game currency acquisition number has reached the specific number,
specifying the acquisition time at which the total game currency acquisition number has reached the specific number,
calculating a period of time from the specified acquisition time to a present time, and
providing the player with a benefit in a game based on the calculated period of time such that the less the calculated period of time, the greater the benefit.

2. A non-transitory computer readable recording medium storing instructions that cause a computer to execute:
calculating game currency consumption numbers that each correspond to a consumption time and indicate a quantity of game currency consumed by a player;
storing, in a storage, the game currency consumption numbers;
obtaining a total game currency consumption number by adding up the game currency consumption numbers in order of the consumption time starting from a most recent consumption time;
monitoring whether the total game currency consumption number has reached a specific number; and
upon determining that the total game currency consumption number has reached the specific number,
specifying the consumption time at which the total game currency consumption number has reached the specific number,
calculating a period of time from the specified consumption time to a present time, and
providing the player with a benefit in a game based on the calculated period of time such that the less the calculated period of time, the greater the benefit.

3. A non-transitory computer readable recording medium storing instructions that cause a computer to execute:
calculating game currency purchase amounts that each correspond to a purchase time and indicate a quantity of game currency purchased by a player;
storing, in a storage, the game currency purchase amounts;
obtaining a total game currency purchase amount by adding up the game currency purchase amounts in order of the purchase time starting from a most recent purchase time;
monitoring whether the total game currency purchase amount has reached a specific number; and
upon determining that the total game currency purchase amount has reached the specific number,
specifying the purchase time at which the total game currency purchase amount has reached the specific number,
calculating a period of time from the specified purchase time to a present time, and
providing the player with a benefit in a game based on the calculated period of time such that the less the calculated period of time, the greater the benefit.

4. The non-transitory computer readable recording medium storing instructions according to claim 1, wherein
the game currency includes paid currency that can be acquired through a purchase procedure by the player.

5. The non-transitory computer readable recording medium storing instructions according to claim 1, wherein
the benefit is to increase a quantity of a reward content in the game, and
the less the calculated period of time is, the more the quantity of the reward content is increased.

6. The non-transitory computer readable recording medium storing instructions according to claim 1, wherein
the benefit is to improve a quality of a reward content in the game, and
the less the calculated period of time is, the more the quality of the reward content is improved.

7. The non-transitory computer readable recording medium storing instructions according to claim 1, wherein
the benefit is to ease a limitation in the game, and
the less the calculated period of time is, the more an amount of easing of the limitation is increased.

8. The non-transitory computer readable recording medium storing instructions according to claim 1, wherein
the benefit is to increase a parameter of a content associated with the player, and
the less the calculated period of time is, the more the parameter is increased.

9. The non-transitory computer readable recording medium storing instructions according to claim 1, wherein
the less the calculated period of time is, the more a benefit provision period is lengthened.

10. An information processing device, comprising:
a storage; and
a control device that:
calculates game currency acquisition numbers that each correspond to an acquisition time and indicate a quantity of game currency acquired by a player,
stores, in the storage, the game currency acquisition numbers,
obtains a total game currency acquisition number by adding up the game currency acquisition numbers in order of the acquisition time starting from a most recent acquisition time,
monitors whether the total game currency acquisition number has reached a specific number, and
upon determining that the game currency acquisition number has reached the specific number,
specifies the acquisition time at which the total game currency acquisition number has reached the specific number,
calculates a period of time from the specified acquisition time to a present time, and
provides the player with a benefit in a game based on the calculated period of time such that the less the calculated period of time, the greater the benefit.

11. An information processing device, comprising:
a storage; and
a control device that:
calculates game currency consumption numbers that each correspond to a consumption time and indicate a quantity of game currency consumed by a player,
stores, in the storage, the game currency consumption numbers,
obtains a total game currency consumption number by adding up the game currency consumption numbers in order of the consumption time starting from a most recent consumption time,
monitors whether the total game currency consumption number has reached a specific number, and
upon determining that the total game currency consumption number has reached the specific number,
specifies the consumption time at which the total game currency consumption number has reached the specific number,
calculates a period of time from the specified consumption time to a present time, and
provides the player with a benefit in a game based on the calculated period of time such that the less the calculated period of time, the greater the benefit.

12. An information processing device, comprising:
a storage; and
a control device that:
calculates game currency purchase amounts that each correspond to a purchase time and indicate a quantity of game currency purchased by a player,
stores, in the storage, the game currency purchase amounts,
obtains a total game currency purchase amount by adding up the game currency purchase amounts in order of the purchase time starting from a most recent purchase time,
monitors whether the total game currency purchase amount has reached a specific number, and
upon determining that the game currency purchase amount has reached the specific number,
specifies the purchase time at which the total game currency purchase amount has reached the specific number,
calculates a period of time from the specified purchase time to a present time, and
provides the player with a benefit in a game based on the calculated period of time such that the less the calculated period of time, the greater the benefit.

13. The non-transitory computer readable recording medium according to claim 1, wherein the instructions cause the computer to further execute:
after determining that the game currency acquisition number has reached the specific number, causing a display to display a notification screen indicating a start of a benefit provision period and details of the benefit.
